(19) United States
(12) Patent Application Publication
(10) Pub. No.: US 2025/0251194 A1
(43) Pub. Date: Aug. 7, 2025

(54) SYSTEM AND METHOD FOR HEAT-TREATING MINERAL MATERIAL

(71) Applicants: thyssenkrupp Polysius GmbH, Beckum (DE); thyssenkrupp AG, Essen (DE)

(72) Inventors: Dirk SCHEFER, Ennigerloh (DE); Guido GRUND, Werl (DE)

(73) Assignees: thyssenkrupp Polysius GmbH, Beckum (DE); thyssenkrupp AG, Essen (DE)

(21) Appl. No.: 18/849,305

(22) PCT Filed: Mar. 30, 2023
(86) PCT No.: PCT/EP2023/058264

§ 371 Date: Sep. 20, 2024

(30) Foreign Application Priority Data
Apr. 8, 2022 (BE) BE 2022/5267
Apr. 8, 2022 (DE) 10 2022 203 597.6

(51) Int. Cl. F27D 17/10; F27B 15/00; F27B 15/10; F27B 15/18; F27D 17/20; F27D 19/00

(52) U.S. Cl. CPC F27D 17/10; F27B 15/003; F27B 15/10; F27B 15/18; F27D 17/20; F27D 2019/0015

(57) ABSTRACT

A plant for heat treatment of mineral material comprises a reactor having at least one gas inlet for admitting offgases, wherein the reactor comprises an activating region for activating the mineral material and an offgas outlet for ejecting offgases from the reactor, wherein the offgas outlet is connected to the at least one gas inlet in such a way that at least a portion of the offgas is supplied to the reactor. A process for heat treatment of mineral material with a reactor, comprises activating the material in an activating region of the reactor and optionally cooling the material in a cooling region of the reactor, wherein the offgas of the reactor is discharged therefrom, wherein at least a portion of the offgas discharged from the reactor is returned to the reactor.

The present invention relates to a system and method for heat-treating mineral material with an entrained flow reactor.

It is well known that the cement and mineral industries require very large amounts of heat for the heat treatment of mineral material. Part of the heat treatment is often carried out in an entrained flow reactor in which the mineral material to be treated is entrained in a hot gas stream, wherein heat exchange between the gas and the mineral material occurs during the residence time in the entrained flow reactor so that the mineral material is preheated, dried, calcined and/or dehydroxylated. The required hot gas stream is provided for example by the offgases of a furnace connected to the entrained flow reactor and/or by combustion of fuel in the entrained flow reactor. DE 10 2012 022 179 A1 and DE 10 2010 008 785 B4 also disclose additional combustion chambers which are connected to the entrained flow reactor and are used to burn typically low-grade fuels (secondary or substitute fuels).

Entrained flow reactors are employed for example to produce clinker substitute materials, for example calcined clays, or for obtaining metals or metal oxides from ore-containing materials. The activation of clays in an entrained flow reactor forms offgases having a CO₂ content which is known to be harmful to the environment.

It is accordingly an object of the present invention to provide a plant and a process for heat treatment of mineral material with an entrained flow reactor which makes it possible to achieve a reduction in the CO₂ content and the pollutants, such as nitrogen oxides, in the offgas.

This object is achieved according to the invention by an apparatus having the features of independent apparatus claim 1 and by a process having the features of independent process claim 9. Advantageous developments will become apparent from the dependent claims.

In a first aspect a plant for heat treatment of mineral material comprises a reactor having at least one gas inlet for admitting offgases, wherein the reactor comprises an activating region for activating the mineral material and an offgas outlet for ejecting offgases from the reactor. The offgas outlet is connected to the at least one gas inlet in such a way that at least a portion of the offgas is supplied to the reactor.

A recycling of at least a portion of the offgas into the reactor effects an enrichment of the offgas of the reactor with CO₂, with the result that the offgas has a high CO₂ content of preferably at least 75% by volume. Such a high CO₂ content is advantageous for a subsequent treatment of the offgas, for example for separation or storage of CO₂.

The reactor is an entrained flow reactor configured as a multi-stage cyclone heat exchanger and comprises a preheating region for preheating the material, and activating region for activating the mineral material and optionally a cooling region for cooling the material. The offgas outlet is preferably arranged in the preheating region, wherein the offgas outlet is connected to the activating region and/or the cooling region of the entrained flow reactor in such a way that at least a portion of the offgas is supplied to the activating region and/or a cooling region. The activating region, the cooling region and/or the preheating region preferably each have at least one gas inlet which is especially connected to the offgas outlet for conducting the offgas into the gas inlet. The activating region, the cooling region and the preheating region are for example arranged at the same height level, in particular side-by-side. It is likewise conceivable for the activating region, the cooling region and/or the preheating region to be arranged at different height levels. It is preferable when the preheating region is arranged above the activating region and the activating region is arranged above the cooling region. The activating region of the entrained flow reactor at least partially comprises a fluidized bed for example.

In a further embodiment the activating region comprises at least one combustion chamber and/or a hot gas generator and the offgas outlet is connected to the combustion chamber and/or the hot gas generator in such a way that at least a portion of the offgas is supplied to the combustion chamber and/or the hot gas generator.

The activating region of the entrained flow reactor comprises for example a heating means, in particular a hot gas generator for generating a hot gas. The heating means is preferably arranged in addition to the combustion chamber and/or the fuel inlet. The heating means is especially connected to the riser conduit of the activating region in such a way that the hot gases generated in the heating means are introduced into the riser conduit below the hot gases generated in the combustion chamber. It is preferable when the heating means comprises a gas inlet for admitting recycled offgas which is preferably connected to the recycle conduit.

The inventors have found that a treatment of the offgas for storage or further treatment of the CO₂ content in the offgas is particularly easily achievable when the CO₂ content of the offgas exiting the plant, in particular the entrained flow reactor, is particularly high, in particular about 70 to 95 vol %, preferably at least 75 vol %. Such a content of CO₂ in the offgas allows simple liquefaction, separation or sequestration of CO₂ for example. The discharged offgas may also be used for example for soda production, sugar production or for production of precipitated calcium carbonate.

The plant for heat treatment of materials optionally comprises a comminution means, such as a mill or a crusher and/or a drying means for treating the material before admission into the reactor.

The reactor, in particular the entrained flow reactor or the fluidized bed reactor, is especially used for heating, preferably activating, the material, wherein an activation comprises for example a calcination, deacidification, dehydroxylation and/or decarbonization of the material.

An entrained flow reactor comprises for example a multi-stage cyclone heat exchanger comprising a preheating region, an activating region and optionally a cooling region in the flow direction of the material. By way of example a cooling gas flows through the cooling region and hot gases flow through the activating region and the preheating region of the various cyclones from bottom to top (relative to the gravitational direction) while the material to be thermally treated flows through the cyclones from top to bottom in countercurrent. It is preferable when in each of the cyclones the material is separated from the gas stream and via an outlet introduced into a gas flow which is subsequently supplied to the cyclone therebelow. In the lower cyclones of the cooling region the gas flow supplied via a compressor for example cools the material while the gas is preheated. Alternatively, in the lower cyclones of the cooling region the material may be cooled by at least one fan in an aspirated process. The preheated gas then flows through the riser pipe of the activating region in which the actual heat treatment of the material supplied from the preheating region is carried out. In the activating region the gas flow is additionally supplied with a hot gas via a combustion chamber or a burner to provide the thermal energy required for the treatment. It is likewise conceivable to supply a fuel to the riser pipe, in particular the activating region, exclusively or in addition to the combustion chamber or burners. The gas exiting the activating region is subsequently utilized in the preheating region for preheating the material.

The preheating region comprises for example a plurality of cyclones, in particular one to five cyclones, through which the material preferably flows successively to preheat the material. The activating region of the entrained flow reactor which follows the preheating region preferably comprises for example one to three cyclones, preferably one cyclone, and/or a riser pipe and at least one combustion chamber and/or a fuel inlet and/or a heating means, such as a hot gas generator.

The activating region preferably comprises a riser pipe which extends substantially in the vertical direction, optionally comprises one or more fuel inlets and/or is connected to the combustion chamber and/or the heating means in such a way that hot gases generated in the combustion chamber and/or the heating means are admitted into the riser pipe. The activating region comprises for example two or more combustion chambers and/or heating means that are connected to the riser pipe. The activating region especially comprises a heating means and a combustion chamber which are connected to the riser conduit in such a way that for example the hot gases respectively generated in the heating means or the combustion chamber are introduced into the riser pipe at different positions, in particular at offset heights. The heating means is arranged below the combustion chamber for example. The material preheated in the preheating region is preferably introduced into the riser pipe of the activating region and heated in cocurrent therein. The riser pipe is followed in the flow direction of the solid gas mixture by a cyclone used for solids separation.

The cooling region which optionally follows the activating region of the entrained flow reactor preferably comprises a plurality of cyclones, in particular two to four cyclones. The cooling region comprises for example a moving bed cooler, a fluidized bed cooler and/or a plate cooler.

The preheating region of the entrained flow reactor preferably comprises a material inlet for admitting material to be treated into the entrained flow reactor. The preheating region preferably comprises an offgas outlet for ejecting offgas of the entrained flow reactor from the entrained flow reactor. The ejected offgas is discharged into an offgas conduit. The offgas is preferably offgas from the preheating region, the activating region and/or the cooling region. The cooling region preferably comprises a gas inlet, for example a cooling gas inlet, which is especially arranged at the lower end region of the cooling region, and especially a region for the material inlet and a region for the material outlet.

The combustion chamber is preferably used for generating hot gases by combustion of oil, coal or gas or secondary fuels, such as end-of-life tires or domestic refuse, and preferably comprises a fuel inlet for admitting fuel into the combustion chamber. The heating means is preferably used for generating hot gases, wherein the hot gas is preferably generated electrically or by combustion of oil, coal or gas. The heating means may also be a heat exchanger for heating a gas stream, wherein the heat exchanger is operated electrically or using a combustion chamber.

At least a portion of the offgas discharged from the preheating region is returned to the entrained flow reactor, in particular the combustion chamber, the activating region and/or the cooling region. The portion of the offgas supplied to the combustion chamber, the activating region and/or a cooling region is also referred to as recycled offgas stream. It is preferable when the combustion chamber, the activating region and/or the cooling region each comprise at least one gas inlet for admitting the recycled offgas, wherein the gas inlet is connected with the offgas outlet of the preheating zone via a conduit. The conduit for supplying the recycled offgas into the combustion chamber, the activating region and/or the cooling region preferably runs at least partially or completely outside the entrained flow reactor.

A recycling of at least a portion of the offgas into the entrained flow reactor effects an enrichment of the offgas of the entrained flow reactor with CO₂, with the result that the offgas has a high CO₂ content of preferably at least 75% by volume. Such a high CO₂ content is advantageous for a subsequent treatment of the offgas, for example for separation or storage of CO₂.

The reactor is for example a fluidized bed reactor and comprises an activating region for activating the mineral material and optionally a cooling region for cooling the material. The offgas outlet is connected to the activating region and/or the cooling region of the fluidized bed reactor in such a way that at least a portion of the offgas is supplied to the activating region and/or a cooling region. The fluidized bed reactor preferably comprises a preheating region which is connected upstream of the activating region. The preheating region of the fluidized bed reactor corresponds for example to the preheating region described with reference to the entrained flow reactor. The offgas outlet is preferably arranged in the activating region or the preheating region.

In a further embodiment the plant comprises a gas analysis means for determining the CO₂ content, the oxygen content and/or the temperature of the offgas, wherein the offgas outlet is connected to the gas analysis means for supplying the offgas.

In a further embodiment the plant comprises a gas flow diverter which is connected downstream of the gas analysis means and is configured in such a way that it divides the offgas into a recycled offgas stream and a discharged offgas stream, wherein the proportion of the offgas streams of the offgas is adjustable. The gas flow diverter is preferably arranged downstream of the gas analysis means in the gas flow direction of the offgas. The gas flow diverter preferably has a recycle conduit arranged downstream of it which is arranged for conducting the recycled offgas and is especially connected to the combustion chamber, the activating region and/or the cooling region for supplying the recycled offgas stream. The discharged offgas stream is preferably ejected from the plant and not returned to the reactor. The discharged gas stream is especially supplied to an offgas treatment means, for example a means for liquefaction, separation or sequestration of CO₂, or supplied to a further process, for example for soda production, sugar production or production of precipitated calcium carbonate. The proportion of the offgas streams of the offgas is especially steplessly adjustable preferably between 0% and 100%. A separation of the offgas into at least two offgas streams provides the advantage of specific recycling of a particular proportion of the offgas into the reactor.

In a further embodiment the plant comprises a control means configured in such a way that it controls the proportions of the offgas streams divided using the gas flow diverter according to the determined CO₂ content, oxygen content and/or the determined temperature of the offgas discharged from the preheating region. The control means is for example arranged in the gas flow diverter or connected to the gas flow diverter.

The control means is preferably configured in such a way that it compares the measured values determined using the gas analysis means with a predetermined threshold value or value range and in case of deviation of the measured value determined using the gas analysis means from the threshold value or the value range increases or reduces the proportions of the offgas streams divided using the gas flow diverter, preferably the amount of recycled offgas. The gas analysis means is preferably connected to the control means for transmitting the determined measured values.

The gas analysis means is for example configured for determining the CO₂ concentration in the offgas and connected to the control means for transmitting the determined CO₂ concentration. The control means is preferably configured in such a way that it compares the CO₂ concentration determined using the gas analysis means with a predetermined CO₂ concentration threshold value or CO₂ concentration range and in case of deviation of the CO₂ concentration determined using the gas analysis means from the CO₂ concentration threshold value or CO₂ concentration range does not alter, increases or reduces the amount of recycled offgas.

Say for example the CO₂ concentration threshold value is 60-90 vol %, in particular 70 to 80 vol %, preferably 75 vol %, of CO₂ in the offgas. The control means is preferably configured in such a way that in the case of an undershooting of the CO₂ concentration threshold value the amount of recycled offgas is increased, with the result that the recycled offgas preferably accounts for 90-100% of the offgas. The control means is preferably configured in such a way that in the case of an overshooting or attaining of the CO₂ concentration threshold value the amount of recycled offgas is reduced, with the result that the recycled offgas preferably accounts for 0-90% of the offgas. It is preferable when the proportion of recycled offgas is 50-70% if the determined CO₂ concentration is less than 80-90 vol %, in particular 75 vol %.

In a further embodiment the plant comprises a source for an oxygen-rich gas, wherein said source is connected to the activating region, the combustion chamber and/or a cooling region of the reactor for supplying the oxygen-rich gas. The oxygen-rich gas is preferably a gas having an oxygen content of about 25 to 100 vol %, in particular 60 to 80 vol %, preferably 79 vol %. The source is a storage means and/or oxygen conduits for example. The recycle conduit comprises an inlet for oxygen-containing gas for example. Supplying oxygen-rich gas offers the advantage of low-pollution combustion. The proportion of CO₂ in the offgas may be increased to allow efficient enrichment for example.

In a further embodiment the control means is configured in such a way that it controls the amount of oxygen-rich gas supplied to the reactor according to the determined CO₂ content, oxygen content and/or the determined temperature of the offgas discharged from the preheating region.

The control means is preferably configured in such a way that it compares the measured values determined using the gas analysis means with a predetermined threshold value or value range and in case of deviation of the measured value determined using the gas analysis means from the threshold value or the value range increases or reduces the amount of oxygen-rich gas to the reactor.

The gas analysis means is for example configured for determining the oxygen content in the offgas and connected to the control means for transmitting the determined oxygen content. The control means is preferably configured in such a way that it compares the oxygen content determined using the gas analysis means with a predetermined oxygen threshold value or oxygen content range and in case of deviation increases or reduces the amount of oxygen-rich gas to the reactor. For example the amount of oxygen to the reactor is increased when the measured value undershoots the predetermined threshold value.

The gas analysis means is for example configured for determining the temperature in the offgas and connected to the control means for transmitting the determined temperature. The control means is preferably configured in such a way that it compares the temperature determined using the gas analysis means with a predetermined temperature threshold value or temperature range and in case of deviation increases or reduces the amount of oxygen-rich gas to the reactor. The amount of fuel to the reactor is increased when the measured temperature value undershoots the predetermined threshold value for example.

The activating region of the entrained flow reactor is at least partially configured as a fluidized bed reactor for example. It is preferable when the activating region is entirely configured as a fluidized bed reactor. The entrained flow reactor especially has no cooling region, with the result that the activating region especially comprises a material outlet for ejecting material from the entrained flow reactor. The plant preferably has a cooler separate from the entrained flow reactor which is configured for example as an entrained flow cooler, fluidized bed cooler, drum cooler, plate cooler, coil cooler or a combination thereof.

The invention also comprises a process for heat treatment of mineral material with a reactor, wherein the material is activated in an activating region of the reactor and optionally cooled in a cooling region of the reactor, wherein the offgas of the reactor is discharged therefrom. At least a portion of the offgas discharged from the reactor is returned to the reactor.

The advantages and configurations described with reference to the plant for heat treatment of mineral material likewise apply in process terms to the process for heat treatment.

The reactor is an entrained flow reactor configured as a multi-stage cyclone heat exchanger and the material is preheated in a preheating region of the entrained flow reactor, activated in an activating region of the entrained flow reactor and optionally cooled in a cooling region of the entrained flow reactor. The offgas of the entrained flow reactor is discharged from the preheating region and at least a portion of the offgas discharged from the preheating region is supplied to the activating region and/or the cooling region of the entrained flow reactor.

In one embodiment the activating region comprises at least one combustion chamber and/or a hot gas generator, wherein at least a portion of the offgas discharged from the preheating region is supplied to the combustion chamber and/or the hot gas generator.

The reactor is for example a fluidized bed reactor and the material is activated in an activating region of the fluidized bed reactor and optionally cooled in a cooling region of the fluidized bed reactor, wherein the offgas of the fluidized bed reactor is discharged from the fluidized bed reactor and wherein at least a portion of the discharged offgas is supplied to the activating region and/or the cooling region of the fluidized bed reactor.

In one embodiment the CO₂ content, the oxygen content and/or the temperature of the offgas discharged from the preheating region is determined.

In a further embodiment determination of the CO₂ content, oxygen content and/or the temperature is followed by division of the offgas into a recycled offgas stream and a discharged offgas stream.

In a further embodiment the proportions of the recycled offgas stream and the discharged offgas stream of the offgas are adjusted according to the determined CO₂ content, oxygen content and/or the determined temperature of the offgas discharged from the preheating region.

In a further embodiment an oxygen-rich gas is supplied to the activating region, the at least one combustion chamber and/or the hot gas generator and/or a cooling region of the reactor.

In a further embodiment the amount of oxygen-rich gas supplied to the reactor is controlled according to the determined CO₂ content, oxygen content and/or the determined temperature of the offgas discharged from the preheating region.

### DESCRIPTION OF THE DRAWINGS

The invention is explained in more detail below on the basis of multiple exemplary embodiments with reference to the appended figures.

FIG. 1 shows a schematic representation of a plant for heat treatment with an entrained flow reactor according to one exemplary embodiment.

FIG. 2 shows a schematic representation of a plant for heat treatment with an entrained flow reactor according to a further exemplary embodiment

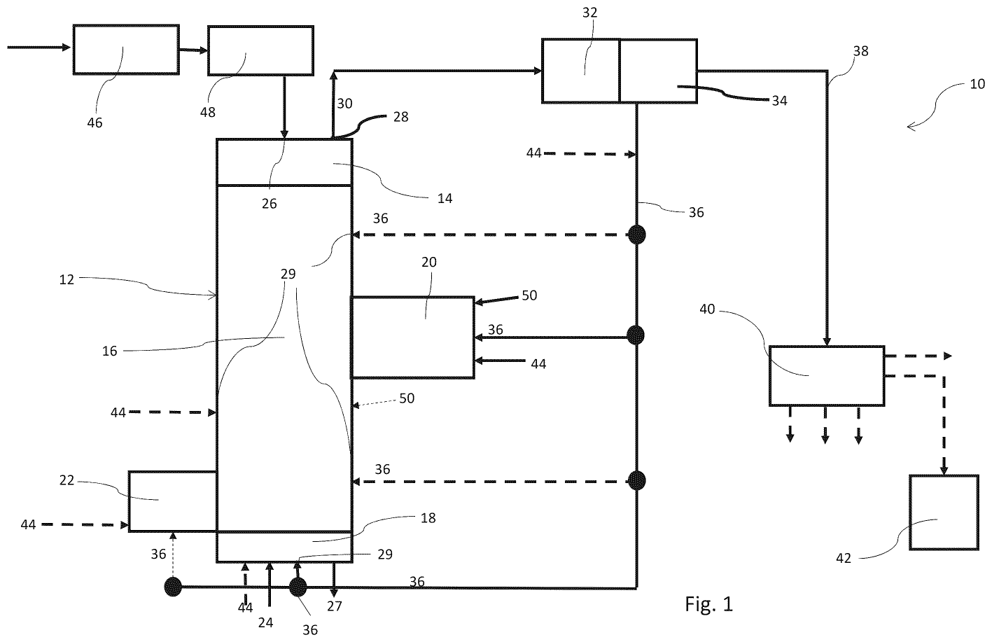

FIG. 1 shows a plant 10 for heat treatment of mineral material. The material is for example selected from mineral materials, limestone, dolomite, magnesite, clays or ore-containing materials. The plant and the corresponding process for heat treatment are preferably used for producing a clinker substitute material or for obtaining metals or metal oxides. The material to be treated is preferably comminuted, in particular milled using a milling plant.

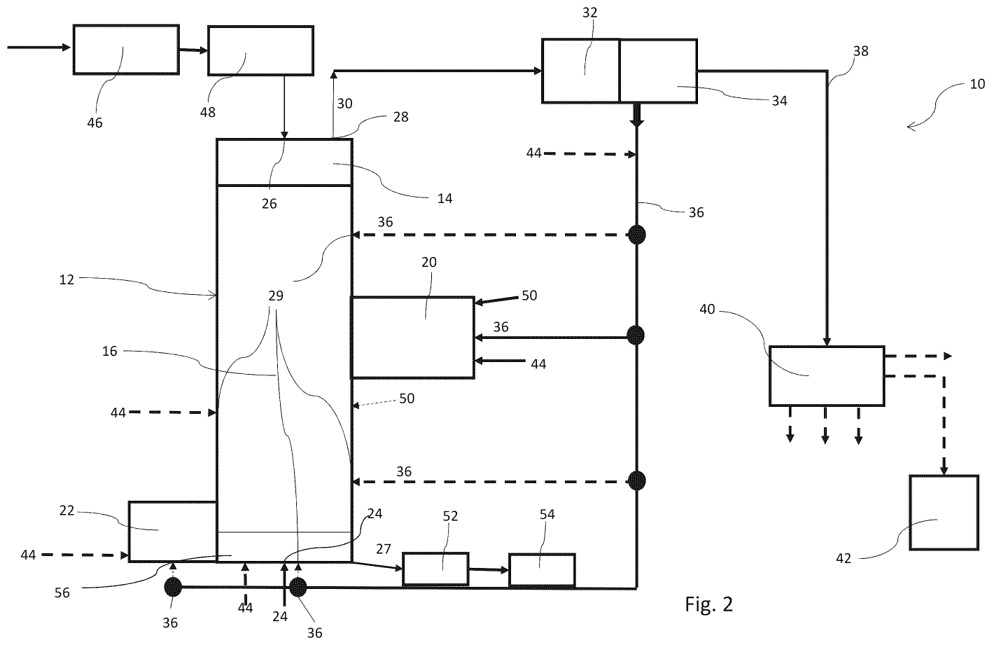

FIGS. 1 and 2 show, by way of example, a reactor 12 configured as an entrained flow reactor. It is likewise conceivable to configure the reactor as a fluidized bed reactor, wherein the description which follows likewise applies to a reactor configured as a fluidized bed reactor substantially such that only the entrained flow reactor 12 or only the activating region 16 of the entrained flow reactor is replaced by a fluidized bed reactor.

The plant 10 comprises an entrained flow reactor 12 shown schematically as a cylinder in FIG. 1, wherein material is introduced into the entrained flow reactor 12 at its upper end and ejected from the entrained flow reactor 12 at its lower end. A hot gas flows through the entrained flow reactor 12 in countercurrent to the material. In the flow direction of the material the entrained flow reactor 12 preferably comprises a preheating region 14 for preheating the material and an activating region 16 for activating the material. The entrained flow reactor 12 optionally further comprises a cooling region 18. In the preheating region 14 the material is preferably preheated to a temperature of 300° C. to 800° C. In the activating region 16 the preheated material is preferably heated to a temperature of 500° C. to 1100° C., especially to effect a decarbonization, dehydroxylation, calcination and/or deacidification of the material. In the cooling region the material is preferably cooled to a temperature of 200° C. to 50° C.

For the sake of simplicity the entrained flow reactor 12 is shown only schematically in FIG. 1. The entrained flow reactor 12 preferably comprises a plurality of cyclones, in particular cyclone stages, which are especially arranged vertically relative to one another or side-by-side. The cyclones are used for separating solids from a gas stream and are connected to one another via gas conduits. The preheating region 14 comprises for example a plurality of cyclones, in particular 1 to 5 cyclones, which are preferably successively traversed by the material to preheat the material. The activating region 16 of the entrained flow reactor 12 comprises for example 1 to 3, preferably 1, cyclone and/or a riser pipe and at least one combustion chamber 20 and/or a heating means 22, for example a hot gas generator.

The combustion chamber 20 preferably comprises a fuel inlet for admitting fuel 50 into the combustion chamber 20. The fuel 50 may for example be selected from secondary fuels, such as end-of-life tires or domestic refuse. The heating means 22 is for example a hot gas generator, wherein the hot gas is preferably generated electrically or by combustion of oil, coal or gas or secondary fuels, such as end-of-life tires or domestic refuse. The heating means may also be a heat exchanger for heating a gas stream, wherein the heat exchanger is operated electrically or using a combustion chamber. The electricity for an electrically operated heat exchanger is preferably obtained from renewable energy sources to an extent of up to 40% to 100%, preferably 60% to 80%.

The activating region 16 preferably has a riser pipe which extends substantially in the vertical direction. The combustion chamber 20 and/or the heating means 22 is preferably connected to the riser pipe in such a way that hot gas generated in the combustion chamber 20 and/or the heating means 22 is admitted into the riser pipe. It is also conceivable for two or more combustion chambers 20 and/or heating means 22 which are connected to the riser pipe to be provided. The activating region 16 for example comprises a heating means 22 and a combustion chamber 20 which are connected to the riser conduit in such a way that for example the hot gases respectively generated in the heating means 22 or the combustion chamber 20 are introduced into the riser pipe at different positions, in particular at offset heights. The material preheated in the preheating region 14 is preferably introduced into the riser pipe of the activating region 16 and heated in cocurrent therein. The riser pipe is followed in the flow direction of the solid gas mixture by a cyclone used for solids separation. The heated material is then preferably supplied to the cooling region 18.

The cooling region 18 of the entrained flow reactor 12 preferably comprises a plurality of cyclones, in particular 1 to 4, preferably 2 to 3 cyclones. The cooling region 18 preferably comprises a cooling gas inlet 24 which is especially arranged at the lower end region of the cooling region.

The preheating region 14 of the entrained flow reactor 12 preferably comprises a material inlet 26 for admitting material to be treated into the entrained flow reactor 12. The preheating region 14 preferably also has an offgas outlet 28 for discharging offgas 30 from the entrained flow reactor 12. The offgas 30 is preferably offgas from the preheating region 14, the activating region 16 and/or the cooling region 18. The plant 10 comprises a gas analysis means 32 which is preferably configured in such a way that it determines the oxygen content, the CO₂ content and/or the temperature of the offgas 30. The offgas outlet 28 is preferably connected via conduits to the gas analysis means 32.

The gas analysis means 32 is preferably followed in the flow direction of the offgas 30 by a gas flow diverter 34 which is configured in such a way that it divides the offgas 30 into at least two offgas streams 36, 38, wherein a portion of the offgas 30 forms the recycled offgas 36 and a portion of the offgas 30 forms the discharged offgas 38.

The recycled offgas stream 36 of the offgas 30 is preferably passed into the cooling region 18 of the entrained flow reactor 12, the combustion chamber 20, the heating means 22 and/or the activating region 16 of the entrained flow reactor 12.

The combustion chamber 20, the heating means 22, the cooling region 18 and/or the activating region 16 of the entrained flow reactor 12 each have a gas inlet 29 for admitting recycled offgas 36.

The gas inlet 29 is preferably arranged in the cooling region 18 or in the lower end of the activating region 16. A gas inlet 29 is optionally arranged in the upper region of the activating region 16, for example in addition to the gas inlet 29 in the cooling region 18 and/or the lower region of the activating region 16. The offgas outlet 28, in particular the gas flow diverter 34, is connected to the respective gas inlets 29 for recycling the offgas 36 into the entrained flow reactor 12.

The amount of the recycled offgas 36 is preferably adjustable using the gas flow diverter 34. For example the plant 10, in particular the gas flow diverter 34, comprises a control means which is configured to control the amount of the recycled offgas 36 according to the at least one measured value determined using the gas analysis means 32. The gas analysis means 32 is preferably connected to the control means of the gas flow diverter 34 for transmitting the determined measured values. The gas flow diverter 34, in particular the control means, is preferably configured in such a way that it compares the measured values determined using the gas analysis means 32 with a predetermined threshold value or value range and in case of deviation of the measured value determined using the gas analysis means 32 from the threshold value or the value range increases or reduces the amount of recycled offgas 36.

The gas analysis means 32 is for example configured for determining the CO₂ concentration in the offgas 30 and connected to the gas flow diverter 34, in particular the control means, for transmitting the determined CO₂ concentration. The gas flow diverter 34, in particular the control means, is preferably configured in such a way that it compares the CO₂ concentration determined using the gas analysis means 32 with a predetermined CO₂ concentration threshold value or CO₂ concentration range and in case of deviation of the CO₂ concentration determined using the gas analysis means 32 from the CO₂ concentration threshold value or CO₂ concentration range increases or reduces the amount of recycled offgas 36.

Say for example the CO₂ concentration threshold value is 60-90 vol %, in particular 70 to 80 vol %, preferably 75 vol %, of CO₂ in the offgas 30. The gas flow diverter 34 is preferably configured in such a way that in the case of an undershooting of the CO₂ concentration threshold value the amount of recycled offgas 36 is increased, with the result that the recycled offgas 36 preferably accounts for 60-100% of the offgas 30 and is introduced into the cooling region 18 via the gas inlet 29. The gas flow diverter 34 is preferably configured in such a way that in the case of an overshooting or attaining of the CO₂ concentration threshold value the amount of recycled offgas 36 is reduced, with the result that the recycled offgas 36 preferably accounts for 0-55% of the offgas 30 and is introduced into the cooling region 18 via the gas inlet 29 of the entrained flow reactor 12.

The discharged offgas 38 is preferably discharged from the plant 10. The plant 10 optionally comprises an offgas treatment means 40. The offgas treatment means 40 is for example a means for liquefaction, separation or sequestration of CO₂. The plant 10 optionally comprises a storage means 42 for storing CO₂ separated in the offgas treatment means 40. It is also conceivable to supply the discharged offgas 38 and/or the offgas treated in the offgas treatment means 40 to a further process, for example for soda production, sugar production or for the production of precipitated calcium carbonate.

The plant 10 preferably comprises at least one or a plurality of inlets for admitting oxygen-rich gas 44. The oxygen-rich gas is preferably a gas having an oxygen content of 25-100 vol %. For example the activating region 16, the combustion chamber 20, the cooling region 18 and/or the heating means 22 each have at least one inlet for admitting oxygen-rich gas 44 into the activating region 16, the combustion chamber 20, the cooling region 18 and/or the heating means 22 respectively. The conduit for recycling the recycled offgas 36 optionally comprises an inlet for admitting oxygen-rich gas 44.

The amount of oxygen-rich gas 44 supplied to the entrained flow reactor 12 is preferably adjustable according to the measured values determined using the gas analysis means 32.

The gas analysis means 32 is for example configured for determining the CO₂ concentration, the temperature and/or the oxygen content in the offgas 30 and connected to the control means for transmitting the determined measured values. The control means is preferably configured in such a way that it compares the CO₂ concentration, temperature and/or the oxygen content determined using the gas analysis means 32 with a predetermined threshold value or value range and in case of deviation increases or reduces the amount of oxygen-rich gas 44 supplied to the entrained flow reactor 12.

The plant 10 optionally comprises a comminution means 46 and a drying means 48 which are connected upstream of the entrained flow reactor 12.

The entrained flow reactor 12 further comprises a material outlet 27 which is arranged for example at the lower end region of the cooling region 18.

The exemplary embodiment of FIG. 2 corresponds substantially to that of FIG. 1, wherein in a departure from FIG. 1 the entrained flow reactor 12 has no cooling region. The plant 10 of FIG. 2 comprises a cooler 52 arranged separately to the entrained flow reactor 12 and optionally a subsequent comminution means 54. The cooler 52 is arranged downstream of the material outlet 27, with the result that the material thermally treated in the entrained flow reactor 12 is supplied to the cooler 52. The cooler 52 is preferably an entrained flow cooler, fluidized bed cooler, drum cooler, plate cooler, coil cooler or a combination thereof.

The lower region of the activating region 16 of the entrained flow reactor 12 of FIG. 2 is optionally configured as a fluidized bed reactor 56.

### LIST OF REFERENCE NUMERALS

10 Plant for heat treatment
12 Entrained flow reactor
14 Preheating region
16 Activating region
18 Cooling region
20 Combustion chamber
22 Heating means/hot gas generator
24 Cooling gas inlet
26 Material inlet
27 Material outlet
28 Offgas outlet
29 Gas inlet
30 Offgas
32 Gas analysis means
34 Gas flow diverter
36 Recycled offgas
38 Discharged offgas
40 Offgas treatment means
42 Storage means
44 Oxygen-rich gas
46 Comminuting means
48 Drying means
50 Fuel
52 Cooler
54 Comminuting means
56 Fluidized bed reactor

1-14. (canceled)

15. A plant for heat treatment of mineral material, comprising:
a reactor having at least one gas inlet for admitting offgases;
wherein the reactor comprises an activating region for activating the mineral material and an offgas outlet for ejecting offgases from the reactor;
wherein the offgas outlet is connected to the at least one gas inlet in such a way that at least a portion of the offgas is supplied to the reactor, wherein the reactor comprises an entrained flow reactor configured as a multi-stage cyclone heat exchanger and a preheating region for preheating the material, an activating region for activating the material, and a cooling region for cooling the material;
wherein the offgas outlet is arranged in the preheating region;
wherein the offgas outlet is connected to the activating region and/or the cooling region of the entrained flow reactor in such a way that at least a portion of the offgas is supplied to the activating region and/or the cooling region.

16. The plant as claimed in claim 15, wherein the activating region comprises at least one combustion chamber and/or a hot gas generator and the offgas outlet is connected to the combustion chamber and/or the hot gas generator in such a way that at least a portion of the offgas is supplied to the combustion chamber and/or the hot gas generator.

17. The plant as claimed in claim 15, wherein the plant comprises a gas analyzer for determining the CO₂ content, the oxygen content and/or the temperature of the offgas and wherein the offgas outlet is connected to the gas analyzer for supplying the offgas.

18. The plant as claimed in claim 17, wherein the plant comprises a gas flow diverter which is connected downstream of the gas analyzer and is configured in such a way that it divides the offgas into a recycled offgas stream and a discharged offgas stream, wherein the proportion of the offgas streams of the offgas is adjustable.

19. The plant as claimed in claim 18, wherein the plant comprises a controller configured in such a way that it controls the proportions of the offgas streams divided using the gas flow diverter according to the determined CO₂ content, oxygen content and/or the determined temperature of the offgas discharged from the preheating region.

20. The plant as claimed in claim 15, wherein the plant comprises a source for an oxygen-rich gas and wherein said source is connected to the activating region, the combustion chamber, the hot gas generator and/or a cooling region of the reactor for supplying the oxygen-rich gas.

21. The plant as claimed in claim 20, wherein the controller is configured in such a way that it controls the amount of oxygen-rich gas and/or the oxygen concentration in the oxygen-rich gas supplied to the reactor according to the determined CO₂ content, oxygen content and/or the determined temperature of the offgas discharged from the preheating region.

22. A process for heat treatment of mineral material with a reactor, wherein the material is activated in an activating region of the reactor, comprising:
discharging the offgas of the reactor therefrom;
returning at least a portion of the offgas discharged from the reactor to the reactor, wherein the reactor is an entrained flow reactor configured as a multi-stage cyclone heat exchanger and the material is preheated in a preheating region of the entrained flow reactor, activated in an activating region of the entrained flow reactor;
discharging the offgas of the entrained flow reactor from the preheating region, wherein at least a portion of the offgas discharged from the preheating region is supplied to the activating region.

23. The process as claimed in claim 22, wherein the activating region comprises at least one combustion chamber or a hot gas generator and wherein at least a portion of the offgas discharged from the preheating region is supplied to the combustion chamber and/or the hot gas generator.

24. The process as claimed in claim 22, wherein the CO₂ content, the oxygen content and/or the temperature of the offgas discharged from the reactor is determined.

25. The process as claimed in claim 24, wherein determination of the CO₂ content, oxygen content and/or the temperature of the offgas is followed by division of the offgas into a recycled offgas stream and a discharged offgas stream.

26. The process as claimed in claim 25, wherein the proportions of the divided offgas streams of the offgas are adjusted according to the determined CO₂ content, oxygen content and/or the determined temperature of the offgas discharged from the reactor.

27. The process as claimed in claim 22, wherein an oxygen-rich gas is supplied to the activating region, the at least one combustion chamber, the hot gas generator, and/or a cooling region of the entrained flow reactor or the fluidized bed reactor.

28. The process as claimed in claim 27, wherein the amount of oxygen-rich gas supplied to the reactor is controlled according to the determined CO₂ content, oxygen content and/or the determined temperature of the offgas discharged from the reactor.

29. The process as claimed in claim 22 wherein the material is cooled in a cooling region of the entrained flow reactor and at least a portion of the offgas discharged from the preheating region is supplied to the cooling region of the entrained flow reactor.

30. A plant for heat treatment of mineral material, comprising:
a reactor having at least one gas inlet for admitting offgases;
wherein the reactor comprises an activating region for activating the mineral material and an offgas outlet for ejecting offgases from the reactor;
wherein the offgas outlet is connected to the at least one gas inlet in such a way that at least a portion of the offgas is supplied to the reactor, wherein the reactor comprises an entrained flow reactor configured as a multi-stage cyclone heat exchanger and a preheating region for preheating the material, and an activating region for activating the material;
wherein the offgas outlet is arranged in the preheating region;
wherein the offgas outlet is connected to the activating region of the entrained flow reactor in such a way that at least a portion of the offgas is supplied to the activating region.
